(19) United States
(12) Patent Application Publication
(10) Pub. No.: US 2016/0377305 A1
(43) Pub. Date: Dec. 29, 2016

(54) SYSTEMS AND METHODS FOR CONTROLLING AN ENVIRONMENT BASED ON OCCUPANCY

(71) Applicant: DunAn Sensing LLC, San Jose, CA (US)

(72) Inventor: TOM KWA, San Jose, CA (US)

(21) Appl. No.: 14/749,217

(22) Filed: Jun. 24, 2015

(51) Int. Cl. F24F 11/00; G05B 15/02

(52) U.S. Cl. CPC F24F 11/006; G05B 15/02

(57) ABSTRACT

Systems and methods for controlling the temperature and humidity in a plurality of spaces are provided. The systems may receive inputs from a temperature sensor, a humidity sensor, an occupancy sensor, a door sensor, and a window sensor. The systems may determine a first space is occupied and a second space is unoccupied. If the occupied space has both doors and windows closed the system may direct motorized vents to shift air flow from an evaporator, burner and humidifier towards the occupied area and away from the unoccupied area.

The present patent document relates to controlling an environment. More particularly, the present patent document relates to controlling an environment based on occupancy.

### BACKGROUND

When heating and/or cooling systems are engaged to control the environment of a room, office or other space, considerable costs may be incurred. Moreover, if these spaces are unoccupied, energy and money may be wasted. It is known in the art that occupancy sensors may be used to control the comfort levels of a dwelling. For example, publication WO2000022491 to Downing et al. (hereinafter “Downing”) discloses an energy saving controller for an air conditioning system in communication with an occupancy detector. Downing discloses a thermostatic controller that has two temperature sets. One temperature set is used by the thermostatic controller when the physical area to be environmentally controlled is occupied and the other temperature set is used by the thermostatic controller when the physical area to be environmentally controlled is unoccupied.

While it may be beneficial to be able to choose between two sets of temperatures based on occupancy, Downing does not teach how to control the environment of individual spaces, only the air temperature to every space. Moreover, there may be other important factors to consider in deciding how to control the environment other than just occupancy. These factors are not considered by Downing. To this end, it would be beneficial to have a system designed to control the environment in individual areas based on occupancy. In addition, it may be beneficial to consider other important factors in an overall environmental control system that factors in both safety and security.

### SUMMARY OF THE EMBODIMENTS

In view of the foregoing, an object according to one aspect of the present patent document is to provide systems and methods to control the environment in various spaces. Preferably the methods and apparatuses address, or at least ameliorate one or more of the problems described above. To this end, a method of controlling the temperature and humidity in a plurality of spaces is provided. In one embodiment the method comprises: receiving inputs from a temperature sensor, a humidity sensor, an occupancy sensor, a door sensor, and a window sensor; determining a first space is occupied and a second space is unoccupied; determining a first space has both doors and windows closed; and, directing a motorized vent to shift air flow from a humidifier and evaporator or burner towards the first area and away from the second area.

In some embodiments, the method may compare inputs from the temperature sensor and humidity sensor with temperature set points and humidity set points respectively. The method may determine that the humidity and temperature of the first space is within the temperature set point range and humidity set point range respectively and cause a motorized vent to shift air flow from a humidifier and evaporator or burner towards the second space.

In addition to controlling vents, other components may be activated. In some embodiments, motorized window blinds may be closed. In other embodiments, a blower may be initiated. In other embodiments, sirens may be activated, skylights may be caused to open or close, gas valves may be opened or closed, sprinklers may be activated or shut off, garage doors may be closed or opened, lights can be turned on or off, or numerous other elements can be controlled.

In another aspect of the present disclosure, a system for controlling an environment in a plurality of separate spaces is provided. In one embodiment, the system comprises a microcontroller; a temperature sensor in communication with the microcontroller; a humidity sensor in communication with the microcontroller; an occupancy sensor in communication with the microcontroller; door sensors in communication with the microcontroller; window sensors in communication with the microcontroller; a compressor and fan in communication with the microcontroller; a gas valve and igniter in communication with the microcontroller; a humidifier in communication with the microcontroller; motorized vents in communication with the microcontroller; and a duct system forming a path for air flow from the evaporator, burner and humidifier to the plurality of separate spaces; wherein the microcontroller is programmed to receive inputs from the temperature and humidity sensors and compare them against a set of target temperature and humidity values and, wherein the microcontroller is programmed to receive inputs from the occupancy, door, and window sensors and, wherein the microcontroller determines a first set of spaces from the plurality of spaces that have temperature or humidity inputs outside their set of target temperature and humidity values and, wherein the microcontroller determines a second set of spaces from the first set of spaces where inputs from the occupancy, door and window sensors determine that the space is: occupied, with windows closed and doors closed and, wherein the microcontroller causes the motorized vents to direct air from the evaporator or burner and air from the humidifier to the second set of spaces.

In some embodiments, the system further comprises a blower located adjacent to a portion of the duct system and in communication with the microcontroller. In yet other embodiments, the system may further include motorized window blinds, motorized skylights, motorized garage doors, sirens, microphones that make the system voice activated, sprinkler systems, gas valve controllers and numerous other components.

In yet another aspect of the present disclosure, a controller for controlling an environment in a plurality of spaces is provided. In one embodiment, the controller comprises: a microcontroller designed to receive inputs from a temperature sensor, a humidity sensor, an occupancy sensor, a door sensor, and a window sensor; the microcontroller further designed to send outputs to a blower, an evaporator and fan, a gas valve and igniter, motorized vents and a humidifier; wherein the microcontroller is programmed to receive inputs from the temperature, humidity, occupancy, door, and window sensors and accordingly cause the motorized vents to close and open such that air from the evaporator or burner and air from the humidifier are directed to spaces that are both occupied and have their external door and external windows closed.

In some embodiments, numerous other sensors provide inputs to the controller. In one embodiment, the controller is further designed to receive an input from a carbon dioxide (CO₂) sensor and causes a window or skylight to open if a CO₂ level is above a CO₂ set point. Other sensors may include smoke detectors, natural gas sensors, carbon monoxide (CO) sensors, particle counters, electromagnetic radiation detectors, vibration sensors, heat detectors and light sensors to name a few.

The systems and methods for controlling an environment are described more fully below. Further aspects, objects, desirable features, and advantages of the systems and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed embodiments.

### BRIEF DESCRIPTION OF THE DRAWINGS

FIG. 1 illustrates an embodiment of a system for controlling an environment in a plurality of separate spaces.

FIG. 2 illustrates a flow diagram of one method for controlling the environment in a plurality of spaces.

FIG. 2A illustrates a flow diagram of valve check for use with the flow diagram of FIG. 2.

FIG. 2B illustrates a flow diagram of a HVAC check for use with the flow diagram of FIG. 2.

FIG. 2C illustrates a flow diagram of humidifier check for use with the flow diagram of FIG. 2.

FIG. 3 illustrates one embodiment of the overall data flow paths of a system for controlling an environment in at least one space.

FIG. 4 illustrates one embodiment of a climate regulation module for use in an environment control system.

FIG. 5 illustrates one embodiment of a safety management module for use in an environment control system.

FIG. 6 illustrates one embodiment of a security management module for use in an environment control system.

### DETAILED DESCRIPTION OF THE EMBODIMENTS

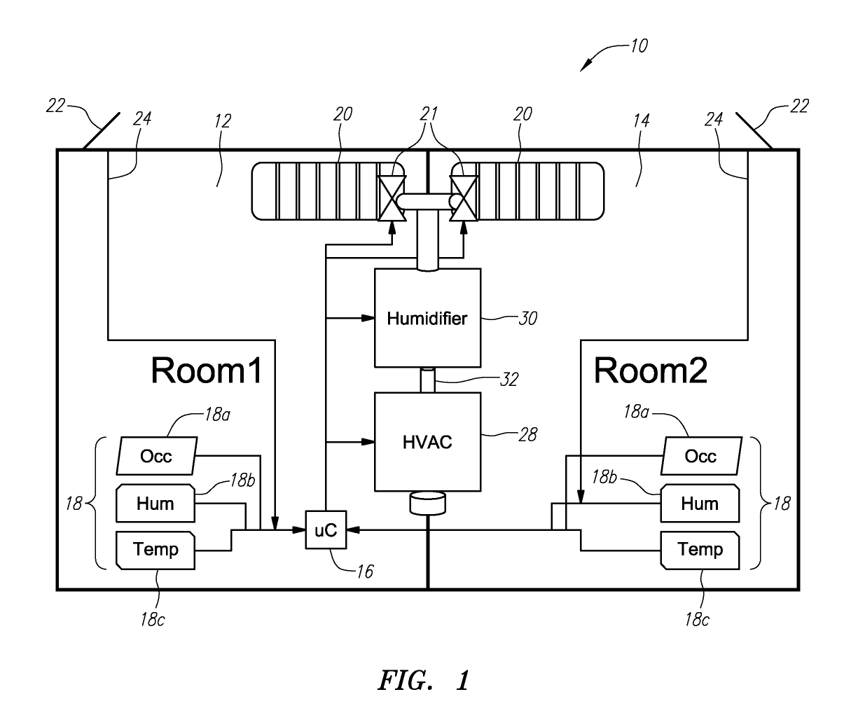

FIG. 1 illustrates an embodiment of a system 10 for controlling an environment in a plurality of separate spaces 12 and 14. As used herein, “spaces” may be any enclosed or partially enclosed area. For example, spaces may be rooms in a house, building, apartment, or warehouse. In other embodiments “spaces” may be any other type of enclosed area. “Separate spaces” are any two partially enclosed areas that are somehow separated. Separation may be complete or partial and may be via a wall, door, hallway or any combination thereof. In general, separate spaces are capable of sustaining a difference in their environments. “Separate Spaces” may be any two spaces that may have their environments separately monitored and controlled. In the embodiment of FIG. 1, the separate spaces 12 and 14 are labeled Room1 and Room2.

As used herein, an “environment” is any aspect of the air in a space including its temperature and humidity. In FIG. 1, the system 10 is designed to control the environment in spaces 12 and 14 separately from one another.

The system 10 includes a microcontroller 16. The microcontroller 16 may be any type of processor including specially designed processors such as an application specific integrated circuit (ASIC) or field programmable gate array (FPGA) or any other type of specialty processor or microprocessor. In yet other embodiments, a more general processor may be used. In such embodiments, the general processor may run specific software designed to allow the processor to perform specialty functions. In preferred embodiments, the microcontroller 16 and/or processor is in data communication with memory. The memory may be non-volatile or volatile memory or a combination of both.

As may be seen in FIG. 1, the microcontroller 16 may be in data and/or electrical communication with a number of sensors 18. The sensors 18 may be any type of sensor. In the embodiment 10 of a system for controlling an environment in a plurality of separate spaces shown in FIG. 1, an occupancy sensor 18a, a humidity sensor 18b and a temperature sensor 18c are used. In the embodiment of FIG. 1, these sensors 18 measure whether Room 1 and/or Room 2 are occupied along with the temperature and humidity of the air in each room. In addition, and in a preferred embodiment like the one shown in FIG. 1, the system 10 may also include door sensors 24. Door sensors 24 may be used to sense whether a door 22 to the room is open or closed. As may be seen, each individual room has its own suite of sensors 18. Each of the sensors 18a, 18b, and 18c provides at least one input to the microcontroller 16.

The microcontroller 16 is also in data and/or electrical communication with a number of devices that can affect the environment in a space. For example, as seen in FIG. 1, microcontroller 16 is connected to a heating ventilating and air-conditioning (HVAC) unit 28. The HVAC unit 28 is directed by the microcontroller 16 and used to provide thermal comfort and acceptable indoor air quality. HVAC 28 can provide ventilation, reduce air infiltration, and maintain pressure relationships between spaces. In some embodiments, the HVAC unit 28 can both add and remove air from spaces 12 and/or 14.

As is known in the art, the HVAC system 28 may be made of various different components or a single component. In general, an HVAC system 28 includes a heating device and a cooling device. The heating device may be a burner, boiler, furnace, heat pump, or other heat generating device. The air conditioning portion of the HVAC unit 28 is typically comprised of an evaporator and fan but may be made from another device and/or contain additional elements.

In the embodiment of FIG. 1, the microcontroller 16 is also connected to a humidifier 30. The humidifier 30 can increase the humidity (moisture) in a space. A humidifier 30 may be attached to a single room or an entire building. In the home, point-of-use humidifiers are commonly used to humidify a single room, while whole-house or furnace humidifiers, which connect to a home's HVAC system 28, provide humidity to the entire house. In the embodiment shown in FIG. 1, the humidifier 30 is connected into the ductwork 32 along with the HVAC system 28. The ductwork 32 connects both the humidifier 30 and the HVAC system 28 with vents 20, which each include a motorized valve 21.

As may be seen in FIG. 1, each room 12 and 14 has its own vent 20 that is controlled by its own motorized valve 21. The microcontroller 16 is in communication with each motorized valve 21. In operation, the microcontroller 16 receives inputs from a plurality of sensors 18 and then based on an internal algorithm, determines how to control the HVAC system 28, humidifier 30 and motorized valves 21 to control the environment of Room 1 and Room 2. To this end, in one embodiment, the microcontroller 16 is programmed to receive inputs from the temperature sensors 18c and humidity sensors 18b and compare them against a set of target temperature and humidity values stored in memory. If the microcontroller 16 determines that one of the spaces or rooms has a temperature or humidity input outside its target temperature or humidity ranges, the microcontroller 16 can direct either a heating device or cooling device from within the HVAC system 28, or humidifier 30 to activate and direct air to the space as required.

In preferred embodiments, the microcontroller 16 may consider other things rather than just the environment to determine when to engage the HVAC system 28 and/or the humidifier 30. For example, the microcontroller 16, may receive inputs from the occupancy, door, and window sensors and determine whether a particular space is occupied, whether the doors are closed or open, whether the windows are closed or open, whether any shades or blinds are drawn or open and other factors affecting the environment of the room. The microcontroller 16 may modify how it chooses to control the heating or cooling devices of the HVAC system 28 and humidifier 30 based on these additional inputs.

In one embodiment, the microcontroller 16 may be monitoring a plurality of separate spaces and may determine that a particular set of spaces, which could be a single space, are/is occupied with the windows closed and the doors closed and control the motorized vents 20 to direct the flow of air from the HVAC system 28 and humidifier 30 away from unoccupied spaces and towards the occupied space. In determining whether to direct air to an occupied space, the microcontroller 16 may also consider whether the doors and/or windows 22 are closed before directing air towards an occupied space. If the doors are open or windows 22 are open, the microcontroller 16 may decide that air should not be directed to the occupied space. In yet other embodiments, the microcontroller 16 may decide to direct air to the occupied space but only try and control temperature and not humidity or humidity and not temperature. This may be accomplished by directing air to the occupied space but only causing the HVAC system 28 to engage and not the humidifier 30 or vice versa.

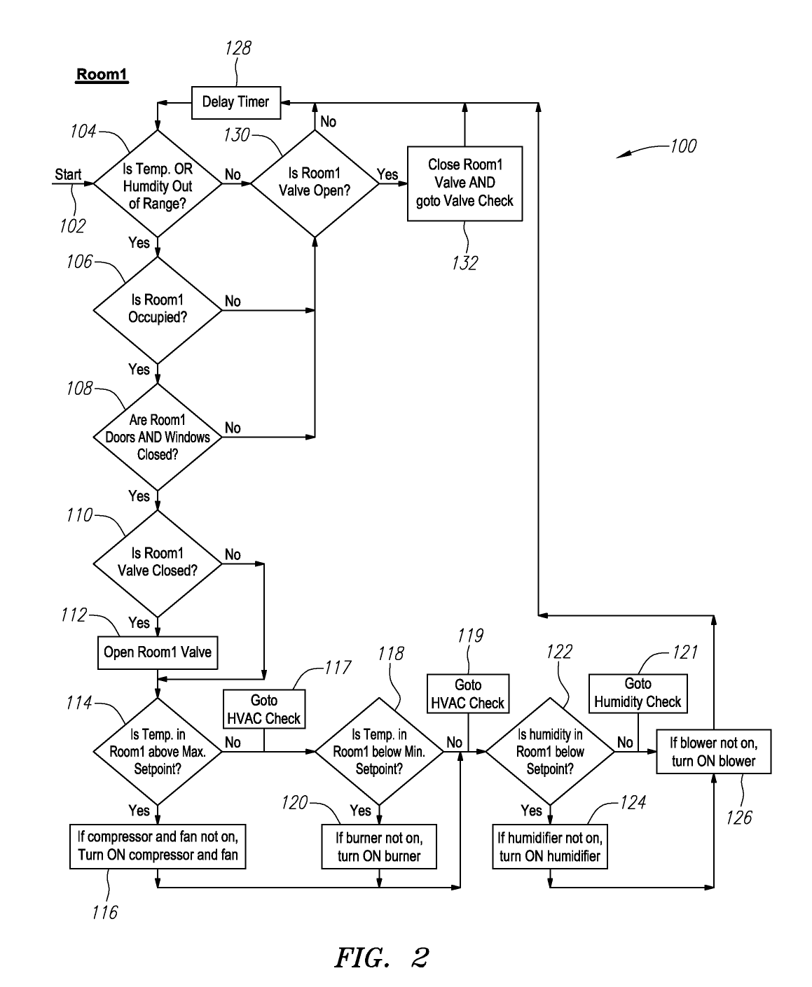

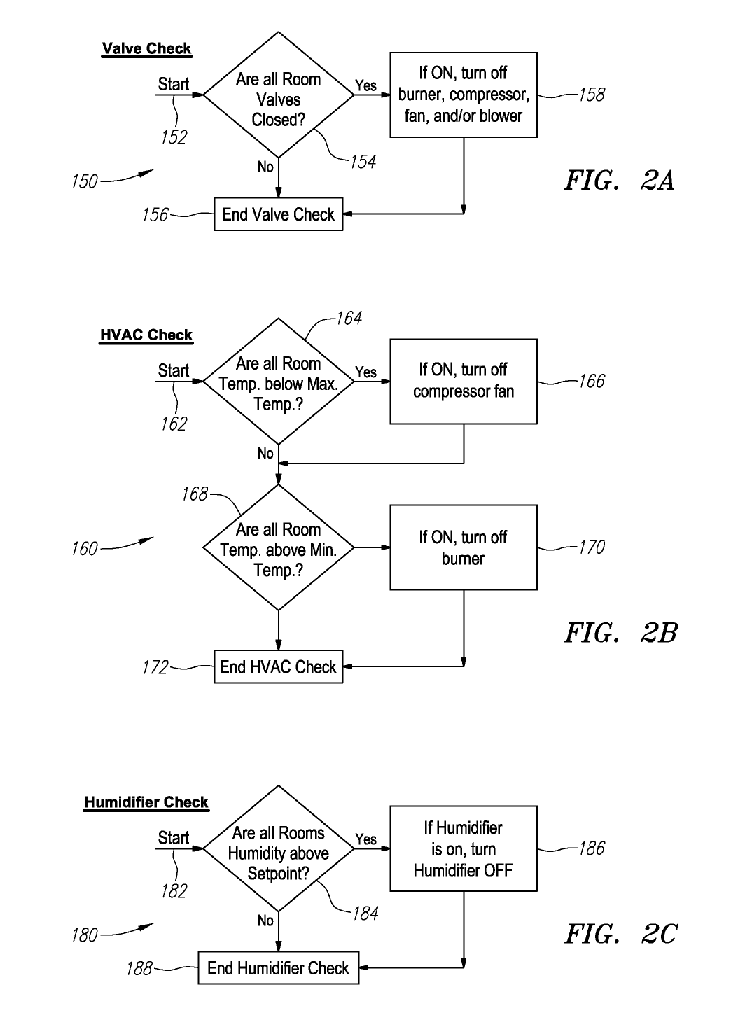

FIG. 2 illustrates a flow diagram of one method for controlling the environment of a plurality of spaces. Although in FIG. 2 only a single space, Room 1, has a diagram, the method may be expanded to an infinite number of spaces by simply copying the flow diagram 100 for Room 1 and running it in parallel for each of the additional rooms.

In FIG. 2, the method starts at 102. The flow diagram in FIG. 2 assumes that a minimum and maximum set point for the preferred temperature for Room 1 has been entered. The minimum and maximum set points for the preferred temperature define an acceptable range for the temperature of Room 1. It is also assumed that an acceptable humidity level has been entered. These values may be stored in volatile or non-volatile memory.

The method 100 begins by determining whether the temperature or humidity in Room 1 is out of the acceptable limits defined by the set point range. If it is not, the process 100 proceeds to check whether the motorized valve controlling the vents to Room 1 is open in step 130. If the valve is not open, the process loops back to step 104 through a delay timer 128. Delay timer 128 is simply a delay to prevent a tight infinite loop around step 104. Delay timer 128 may be set to any delay amount. In a preferred example, the delay timer may be a minute or a couple of minutes. However, in other embodiments, the delay timer may be any value including zero all the way up to a plurality of hours or days.

If the check to see whether the Room 1 valve is open confirms that the valve is open, then the Room 1 valve is closed in step 132. Once the valve is closed the process returns to step 104 through delay timer 128. However, anytime a valve is closed, the valve check process 150 is initiated.

FIG. 2A illustrates a flow diagram of a valve check for use with the flow diagram of FIG. 2. The valve check process 150 starts at 152. The first step is to determine if all the valves for each of the separate spaces being controlled are all closed. If every valve to every space is closed, then the process proceeds to step 158 and checks to see whether any of the environmental control equipment is running. For example, in an embodiment with three rooms, step 154 would check whether the valve to each of the three rooms was closed, if they were, the process would proceed to step 158. In step 158, all environmental control equipment that may be on is turned off. In the present example, a burner, compressor, fan and/or blower are all turned off. This is because with all the valves closed, there is no need for any of the environmental control equipment to be running.

In another embodiment, which includes a CO₂ sensor, the fan could be turned on and the vents could be opened if a certain CO₂ level is exceeded. Furthermore, to ensure air freshness, the fan could be turned on and the vents could be opened periodically, regardless of occupancy, temperature, humidity or CO₂ level. To this end, a timer may be incorporated that checks for the status of the vents. If the vents have been continuously closed for the duration of the timer, the timer may open the vents and engage at least the fan for a certain period of time and then reclose the vents and disengage the fan.

Once all the environmental control equipment is commanded to off, the valve check ends. The valve check also ends if at step 154, it is determined that not all the valves are closed.

Returning to initial step 104 in FIG. 2, if at step 104, the process determines that the environment of the room is not within the set points, then the process proceeds to step 106 and checks to see if the room is occupied. The environmental conditions in the process 102 shown in FIG. 2 only include temperature and humidity. However in other process, other environmental conditions may be verified including but not limited to air quality and air cleanliness. This may be particularly important in clean rooms or rooms that required frequent ventilation.

At step 106, if the room is unoccupied, the process returns to step 130 and repeats. If the room is occupied, the process proceeds to step 108 and the window and/or door sensors are checked to determine whether the windows and/or doors are closed in the room. If there are open windows or doors, the process returns to step 130 and repeats. If all the windows and doors are closed, the process proceeds to step 110 and checks to see if the room valve is closed. At this point, it has been determined that the environment in the space being monitored is not within the acceptable set points and thus, should be controlled by the system. To this end, if the valve to the room is currently closed, it is opened in step 112. If the valve is already open, the opening step is skipped. In both cases, the process 102 continues with step 114.

In step 114, the input from the temperature sensor, or in some embodiments, a plurality of temperature sensors, is compared against the maximum temperature set point. If the temperature in the room is above the maximum temperature set point for that room, the process checks to see if the compressor and fan are on and if they are not, they are turned on in step 116. The process continues by skipping over step 118, which checks to see if the temperature in the room is below the minimum set point, and continues.

Returning to step 114, if step 114 determines the temperature in the room is below the maximum temperature set point, the process proceeds to step 117 and 118.

Step 117 is an HVAC check 160. FIG. 2B illustrates a flow diagram of a HVAC check for use with the flow diagram of FIG. 2. The HVAC check 160 checks to see if any of the units of the HVAC system need to be turned off. As an example, an HVAC system may include a burner for heating and a compressor and fan for cooling. The HVAC checks to make sure none of these components are active unless they need to be. The HVAC check 160 begins at step 162 and checks to see if the temperature in every space/room with its room valve open is below the maximum temperature set point for that space/room at step 164. In this particular embodiment, the temperature of the rooms with the room valve closed do not need to be checked because they are not receiving any environmental conditioning at the current time. If all the rooms with their room valves open have a temperature below their maximum temperature set point, then there is no reason to have the compressor and fan active and in step 166 if these units of the HVAC system are on, they are turned off. Next the HVAC check 160 proceeds to step 168 and checks to see if the temperature in every space/room with its room valve open is above the minimum temperature set point for that space/room at step 168. If they are, then there is no reason to have the burner active and in step 170 if the burner is on, it is turned off. The HVAC check 160 ends at step 172.

Returning to the main loop 100 in FIG. 2, the process continues with step 118 to determine whether the temperature in Room 1 is below the minimum set point programmed for Room 1. If the temperature in the room is below the minimum temperature set point for that room, the process checks to see if the burner is on if it is not, the burner is turned on in step 120. The process continues to step 122.

Returning to step 118, if step 118 determines the temperature in the room is above the minimum temperature set point, the process proceeds to step 119 and activates the HVAC check 160 shown in FIG. 2B. The HVAC check performs as described above and will turn off the burner if all of the spaces with their room valve open have a temperature above the temperature set point.

Returning to the main loop 100, the process continues with step 122. In step 122, the humidity in Room 1 is checked to see if it is below the humidity set point. The humidity of the Room 1 may be determined from the input of humidity sensor placed in the room. If the humidity of the room is below the set point, the process proceeds to step 124 and the humidifier is turned on. If the humidity level in Room 1 is determined to not be below the humidity set point, the process proceeds to the humidifier check 180.

FIG. 2C illustrates a flow diagram of a humidifier check for use with the flow diagram of FIG. 2. The humidifier check 180, similar to the HVAC check 160, determines whether the humidifier needs to be activated. The humidifier check starts at 182 and checks to see if the humidity levels in every room that has an associated open room valve, are above the humidity set point for that room 164. If all the rooms with open room valves have acceptable humidity levels and the humidifier is on, the humidifier is turned off in step 186. If the humidity levels are not acceptable in each room with an open room valve, no action is taken and the humidifier check ends in step 188.

Returning again to the main Room 1 diagram 100 in FIG. 2, the process proceeds to 126. At 126, the process checks to determine whether the blower is on. If the blower is not on, the blower is turned on. The blower is turned on regardless of whether the process reaches block 126 via the “no” path from block 122 or the “yes” path from block 122 because in order to get in this part of the loop, either the temperature or humidity must have been outside the acceptable range and in either case the blower needs to be activated. Once the blower is confirmed on, the process returns to the beginning and passes through the delay timer 128 and back to block 104.

In FIG. 2, a flow chart for only a single room, Room 1, is shown. However, multiple rooms may be monitored by adding a separate parallel monitoring thread for each room. In any multithreaded system, hand offs and/or state machines may be used to ensure the correct processing of the independent loops.

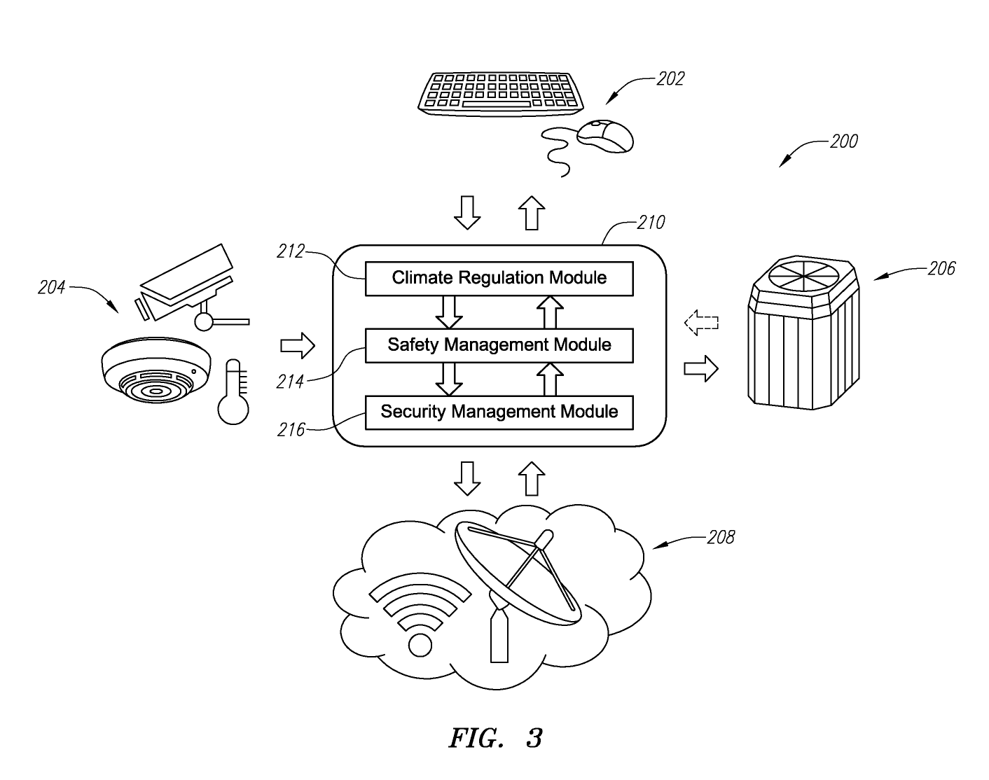

FIG. 3 illustrates the overall data flow paths for a system 200 for controlling an environment in at least one space. System 200 includes a user interface 202, sensors 204, environmental control 206, connectivity 208, and central controller 210.

The user interface 202 may include various different components. In a preferred embodiment a touch screen may be used. In other embodiments, a keyboard, mouse, remote control or microphone may be part of the user interface 202. In other embodiments, the user may log in remotely from a cell phone, tablet, laptop or other portable device and the user interface 202 will be displayed on the mobile device. In preferred embodiments, the user interface 202 is formatted for the particular user device being used. The user interface 202 is designed to receive commands from a user and transmit those commands to the central controller 210. The central controller 210 can also send information and data back to the user interface to update the user interface.

The system 200 also includes a suite of sensors 204. The suite of sensors 204 may include sensors, cameras or detectors. In some embodiments, these elements may be wirelessly connected. In other embodiments they may be hard wired. The suite of sensors 204 sends data to the central controller 210.

The suite of sensors 204 may use many different kinds of sensors to monitor many different aspects of the environment. The sensors may be any type of sensor including sensors that detect, light, motion, temperature, magnetic fields, gravity, humidity, moisture, vibration, pressure, electrical fields, electromagnetic radiation, sound, cigarette smoke, pollen, odors, and other physical and/or chemical aspects of the environment. The sensors may be used to monitor or detect a number of different events. In preferred embodiments, the system may include a sensor to detect or monitor the air temperature in the space, the humidity of the air in the space, whether the space is occupied by humans, animals or a combination thereof, whether the doors to the space are open or closed, whether the windows in the space are open or closed, whether any other openings such as skylights or animal doors are open or closed, whether blinds or shades over those openings are open or closed or in some stage of partial closure, or various other aspects of the environment.

The system 200 also includes a connectivity element 208. The connectivity element may connect the central control unit 210 and the entire system 200 to a communications network. The central controller 210 and the connectivity unit 208 exchange data back and forth. The connectivity unit may consist of a telco phone system, GSM connection, Internet connection, WiFi or any other type of data communication connection. The connectivity element 208 allows remote access to the control unit 210. Remote access to the central control unit 210 allows a user to not only remotely view the data and status of the environmental control system 200, it may also allow a user to change the settings of the system 200.

The environmental control system 200 also includes an environmental control 206. The environmental control 206 may comprise an HVAC system including a heating element and a cooling element. For example, the HVAC system may include a burner and fan for heating and a compressor and fan for cooling. In addition, the environmental control 206 may include a humidifier system, appliances, gas and water valves, lights, sirens, locks and any other physical hardware necessary to control the environment in a space.

The central control unit 210 sends data to the environmental control 206. In preferred embodiments, the environmental control 206 may also send feedback to the central control system 210. For example, in systems that use closed-loop control of devices in the environmental control 206, the environmental control 206 will need to send data back to the central control unit 210.

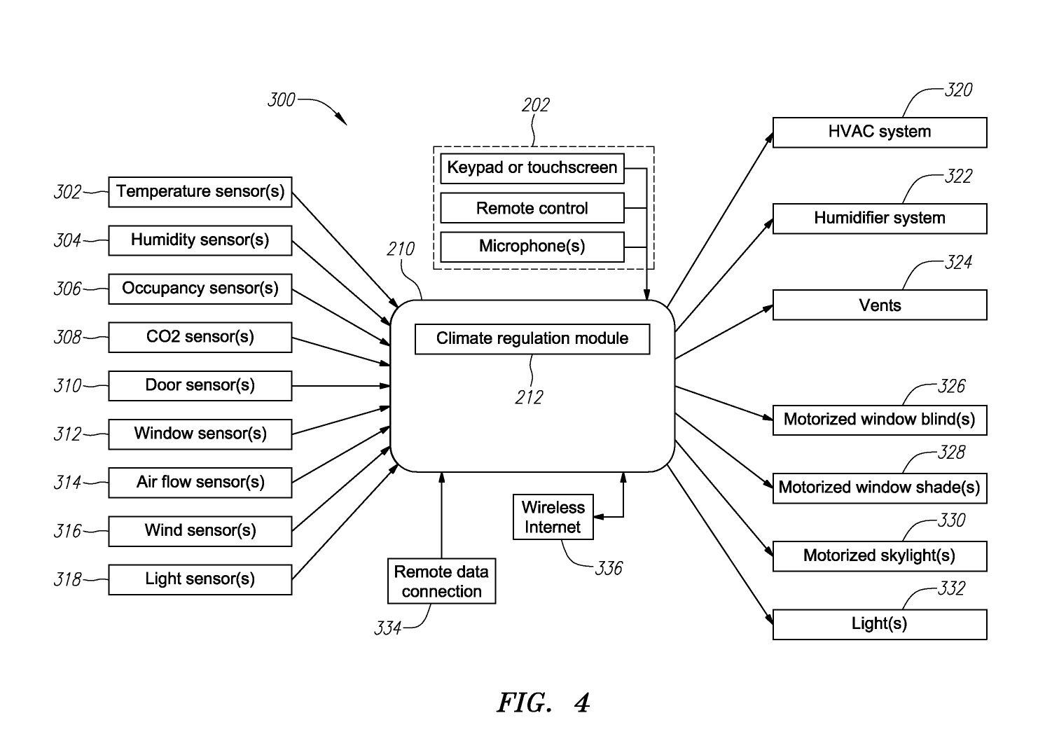

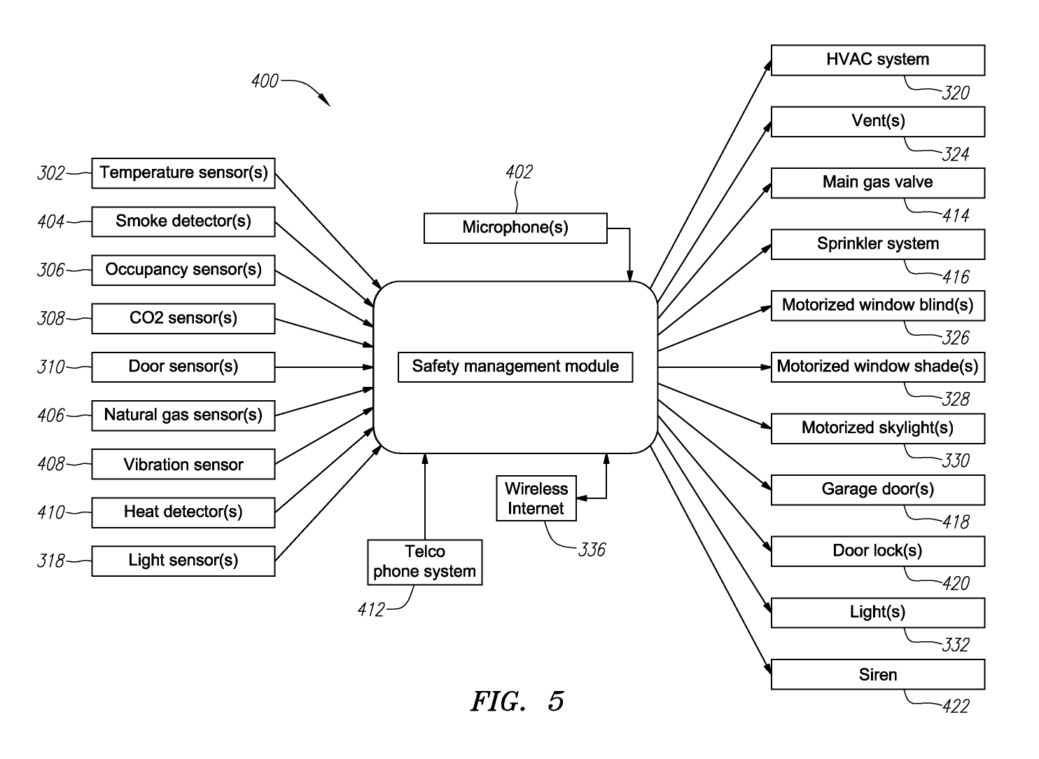

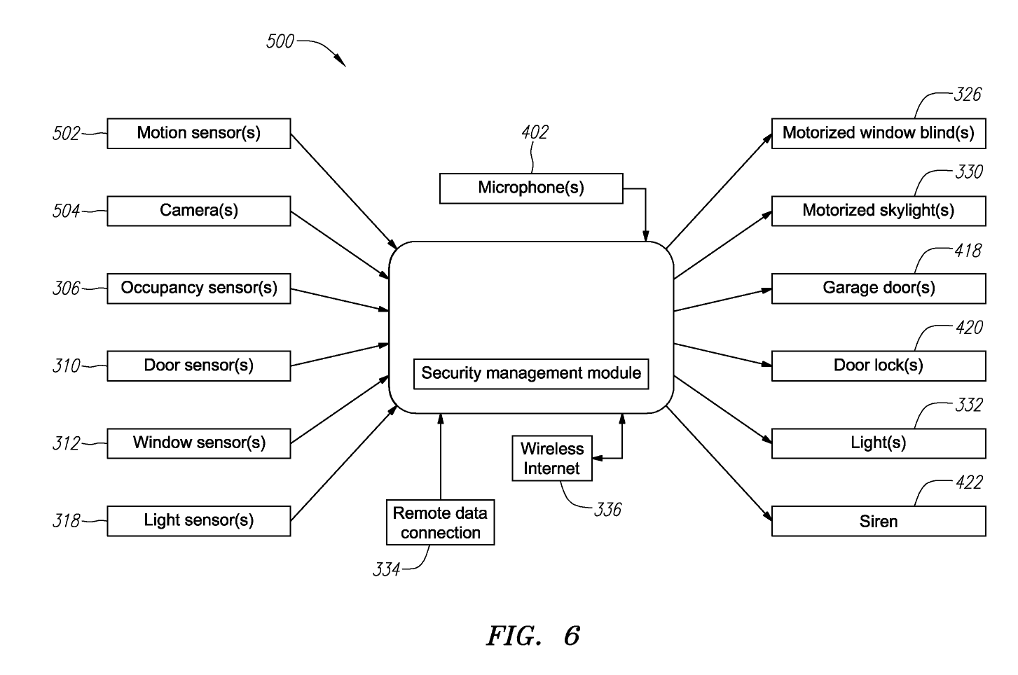

The central control unit 210 may include a plurality of sub-modules. In the embodiment shown in FIG. 3, the central control unit 210 includes a climate regulation module 212, a safety management module 214 and a security management module 216. Each sub-module may interact with the various components of the system. FIGS. 4, 5, and 6 are used to illustrate how each of the three modules shown in FIG. 3, interact with the various portions of the environmental control system 200. Their interactions are discussed below.

The climate regulation module 212 is used to control the climate in a plurality of spaces. In order to set the parameters for the environment in any particular space, the climate regulation module may receive parameters entered by a user. The parameters may be entered through user interface 202. Parameters may also be pre-programmed, downloaded from a remote source or entered through other means. In some embodiments, the climate control module 212 may include a microphone and voice activation and recognition software such that it can recognize and respond to commands issued by a user speaking them. The user may request the climate control module 212 to adjust the temperature set points or any number of other parameters by simply speaking the commands.

The climate regulation module 212 may receive a number of inputs from a variety of sensors and other detection devices. The climate regulation module 212 may receive room temperatures and/or outdoor temperatures from temperature sensor(s) 302. The climate control module may receive data on the humidity levels in a room or rooms from humidity sensor(s) 304. The climate regulation module 212 may receive information about whether a space is occupied from occupancy sensor(s) 306. In a preferred embodiment, the occupancy sensor(s) 306 may be able to provide data as to the number of people in the room. In some embodiments, Carbon Dioxide (CO₂) sensors may transmit information about CO₂ levels in the room to the climate regulation module 212. The climate regulation module 212 may receive information about whether the doors and/or windows in a room are open or closed. In a preferred embodiment, magnetic door sensor(s) 310 and magnetic windows sensor(s) 312 may be used. In other embodiments, other types of sensors may be used to detect whether the windows and/or doors are closed or open. In some embodiments, air flow sensor(s) 314 may also be used to send information about the air flow in the room back to the climate regulation module 212. Wind sensor(s) 316 may also transmit information about the wind speeds outside the room to the climate regulation module 212. In addition, light sensor(s) 318 may be used to send information about the brightness inside and outside the room to the climate regulation module 212. Information about brightness may include brightness of sunlight or whether particular lights are on or off, and their respective brightness and direction.

The climate regulation module 212 may use the various inputs from different sensors and compare them to various set points. Depending on the comparisons, the climate regulation module may activate various components to regulate the environment. For example, if the climate regulation module 212 receives an unacceptable air temperature reading from the temperature sensors 302, the climate regulation module 212 may activate an HVAC system to provide thermally controlled air to adjust the air temperature in a space or spaces. The thermally controlled air may be hotter or colder than the current air temperature. In preferred systems, the HVAC system may not be activated by the climate regulation module 212 if it is determined from the occupancy sensors 306 or a combination of sensors, that the space is unoccupied.

In another example, the climate regulation module may receive an indication from the humidity sensors 304 that the humidity in a monitored space is below the acceptable humidity levels. The climate regulation module 212 may activate a humidifier system 322 to provide air with a higher humidity level than currently in the space to raise the humidity to acceptable levels. In preferred embodiments, the humidifier system 322 may not be activated if no one is at home nor on the way home.

In yet another example, if the climate regulation module 212 gets a reading from an exterior temperature sensor 302 that determines it is hot outside and also determines from an occupancy sensor that no one is home, the climate regulation module may automatically instruct the motorized window blinds 326 or motorized window shades 328 to close. In a preferred embodiment, the climate regulation module 212 may be programmed to only perform this action if the exterior temperature exceeds a programmed threshold away from the interior temperature. In an even more preferred embodiment, the climate regulation module may compare the exterior temperature with a programmed interior temperature set point rather than the actual temperature. In such an embodiment, the climate regulation module may only activate the motorized window shades 326 and/or motorized window shades 328 if the exterior temperature is past a set threshold above the interior temperature set point. In addition to windows, motorized skylight covers may be activated in a similar manner.

In another example, the climate regulation module 212 may receive input from an air quality sensor, for example CO₂ sensor 308 or air flow sensor 314, that the air quality in a particular space has deteriorated beyond an acceptable level. In response, the climate regulation module 212 may activate motorized skylights or windows in order to vent the room and get fresh air. In a preferred embodiment, the space or spaces may also have gas sensors that may detect unacceptable levels of gas. This may be caused from, for example, a gas leak or a stove burner that was not completely turned off. A detected unacceptable level of gas may also cause the climate regulation module 212 to take action to vent the space.

In some embodiments, the HVAC system 320, humidity system 322 and other environmental controls may be separated from one or more spaces by a vent 324. Each space may have a dedicated vent 324. The climate regulation module 212 may control each vent such that even though the HVAC system 320, humidity system 322 or other environmental control system is on, the output is only directed into the particular spaces that require it. As just one example, assuming a residential house has a plurality or rooms, a separate vent 324 may control air flow into each room. The vent(s) 324 may be controlled by the climate regulation module 212. In some embodiments, the climate regulation module may open or close vent(s) 324 as needed to direct air flow into only those rooms that are occupied. In addition, the climate regulation module may also determine to take other actions such as operating motorized window blinds 326 based on room occupancy.

In some embodiments, a data connection 334 that provides locational services may be in data communication with the climate regulation module 212. Data connection 334 may be a GSM, LTE, 3G, 4G or some other wireless protocol. In some embodiments, the data connection 334 provides locational services to the occupants' portable devices. To this end, when activated, the data connection 334 may provide information to the climate regulation module 212 about an occupant's distance from home and direction of travel. Based on information from the data connection 334, the climate regulation module 212 may decide to activate or deactivate various system components. For example, if it is determined that an occupant is approaching a previously unoccupied home, the climate regulation module 212 may activate the HVAC system and humidifier to begin to regulate the environment of various spaces prior to the spaces actually being occupied.

In still other embodiments, the data connection 334 may be used in combination with a mobile interface such as a mobile device application or website and allow the user to access the climate regulation module 212 and manually activate or deactivate various system components. In addition, the data connection 334 and mobile interface may be used to allow the user to change various set points or conditions the climate regulation module 212 responds to.

In some embodiments, the climate regulation module 212 may also contain a wireless Internet connection 336. In preferred embodiments, the wireless Internet connection 336 is an IEEE 802.11 (a.k.a. WiFi) connection. The WiFi connection may allow the climate regulation module to report statistics on climate conditions and energy use. These statistics may be accessible via a website or mobile application. The website and statistics may be accessible through the Internet or only via a local connection. The wireless Internet connection 334 may also, similar to the data connection 334, allow manual activation of system components and or control set points or other aspects of the system remotely.

Similar to the use of a single climate regulation module 212 to control climate in various spaces, a single safety management module 214 may be used to provide safety to a plurality of different spaces. Parameters for the safety management module may be entered from a user or may be pre-programmed. The parameters may be entered through a user interface located on the device or remotely. In addition, the safety management module 214 may be connected to a microphone 402. The microphone may have voice activation and voice recognition capability. To this end, the microphone may be able to detect an audible call for help. The safety management module, having received an audible call for help, may notify emergency personnel via a telco phone system 412, WiFi connection 336, or any other means of communication.

Similar to the climate regulation module 212, the safety management module 214 may receive a number of inputs from a variety of sensors and other detection devices. However, the safety management module 214 may be monitoring parameters and responding to them in a very different way from the climate regulation module 212. For example, the safety management module 214 may receive room temperatures and/or outdoor temperatures from temperature sensor(s) 302. Rather than activate an HVAC unit the safety management module 214 may simply report them or try and notify the occupant if they become excessive. To this end, an excessive temperature range may be programmed or pre-programmed into the safety management module 214.

The safety management module 214 may also receive information about whether a space is occupied from occupancy sensor(s) 306 and store or report that information. In an emergency, the safety management module 214 may provide the occupancy levels to emergency personnel.

In preferred embodiments, the safety management module 214 may alert if it detects an unsafe condition from one of the sensors. The alert may be locally audible, may be sent to one or more mobile devices owned by occupants, may be sent to emergency personnel such as police or fire departments, or may be sent to any other source. Alerts that need to be sent remotely may be sent by the safety management module 214 via the telco phone system connection 412 or wired or wireless Internet connection 336.

As some non-limiting examples, the safety management module 214 may send an alert when: Carbon Monoxide (CO) sensors 308 detect an unsafe limit of CO in a room; smoke detectors 404 detect an unacceptable level of smoke; a natural gas sensor 406 detects an unacceptable level of natural gas; vibration sensors 408 detect an earthquake; or, heat detectors 410 detect a fire. Of course, in other embodiments, other sensors and other alerts may be used.

The safety management module 214 may also receive inputs from light sensors 318 and report outdoor light brightness and direction. In addition, the safety management module 214 may receive inputs from door and window sensors 310 and alert or report if a door or window is opened, left unlocked or closed.

In addition to alerting, the safety management module 214 may take more sophisticated actions to try and mitigate perceived risks. For example, if the safety management module 214 detects a fire or earthquake, the safety management module 214 may turn the lights 332 on, sound a siren 422, unlock the doors or windows 420, open the garage door 418 or close the main gas valve 414.

Some other non-limiting examples of actions that may be taken by the safety management system 214 include, if an earthquake is detected, the safety management module 214 may close the window shades 328. If an intruder is detected, the safety management module 214 may turn on all the lights and notify authorities. If a fire is detected, a sprinkler system 416 may be activated. The sprinkler system may be an interior or exterior system. If the natural gas sensor 406 detects an unacceptable level of gas, the safety management module 214 may turn off the main gas valve 414.

The safety management module 214 may also turn on and off various systems depending on the type of emergency. The HVAC system 320 may be turned on or off in case of, and depending on, the type of emergency. The vents 324 may be opened or closed in case of, and depending on, the type of emergency. The window blinds 326 may be opened or closed in case of, and depending on, the type of emergency. The skylights 330 may be opened or closed in case of, and depending on, the type of emergency. In other embodiments, other various components may be programmed to open or close or be turned on or off in case of, or depending on the type, of emergency.

In addition to the climate regulation module 212 and the safety management module 214, the system may include a security management module 216. Similar to the other modules, the security management module 216 may have various different parameters set through a user interface, may receive various inputs from sensors and alert on them, and may take various actions to try and mitigate potential security situations.

In some embodiments, motions sensors 502 may be set up to detect various different kinds of motions. The security management module 216 may be programmed to respond differently to different types of detected motions depending on various different parameters. For example, if a home is occupied and it is daytime, motion detection may be ignored. However, if it is the middle of the night and motion is detected in close proximity to the exterior of the house, an alert may be initiated.

In addition to motion sensors 502, cameras 504 may also be used. Image analysis may be done on the captured video or images from the cameras 504 or the video may simply be recorded for future use.

Similar to how the safety management module 214 reported occupancy, the security management module 216 may also be aware of, record, or report occupancy. For example, if an intrusion is detected, the security management module 216 may report the intrusion via the data connection 334 and a 911 call and inform the operator or police whether the home is occupied and/or by how many people. In other embodiments, the Internet connection 336 may also be used to alert of an intrusion.

Similar to the motion sensors 502 and cameras 504, door sensors 310 and window sensors 312 may also be used to detect intrusion. In preferred embodiments, the security management module 216 may be programmed to distinguish between a forcible entry and a normal entry. If a window or door if forcibly opened, it may be reported while normal entries may not be reported. In yet other embodiments, opening a window or door may always be reported if the system is programmed to report such an event. As just one example, a family on vacation may set the security management module 216 to alert or report any type of opening or entry.

Also similar to the safety management module 214, the security management module 216 may receive inputs from light sensors 318 and report outdoor light brightness and direction.

In addition to alerting, the security management module 216 may also take actions to try and mitigate a security concern. As some non-limiting examples, the security management module 216 may activate motorized window blinds 326 to open all the window blinds in the case a home invasion is detected. Skylights 330 may be closed if there is no one home and/or it is after bedtime. Skylights and windows may also be closed if rain or wind is detected. Inclement weather may be detected via sensors or via weather reports accessed via the Internet connection 336. To this end, tornado or hurricane warnings may cause siren 422 to be activated.

In other examples, the garage door 418 may be automatically closed if it has been left open too long and the house is unoccupied or the house is occupied but without motion being detected. Lights may be automatically turned on if the room is dark and motion is detected. Doors may be locked if there are no occupants and or it is after bed time. A siren 422 may be activated if a home invasion is detected.

Although the sub-modules 212, 214, and 216 have been described above as separate modules, their functions and features may be integrated into a single module or be broken into additional modules. In addition, functions described as belonging to a particular module may instead be included in one of the other modules without departing from the scope of the present disclosure.

Integration of this home system with a smart phone and a car navigation system allows for a plurality of novel home control scenarios. For example, suppose a home owner programs their car navigation system to head home to what is presently an unoccupied home. The car navigation system could communicate with the home automation system to alert the home automation system that an occupant is headed home. To that end, an estimated time of arrival along with other information may be communicated to the home automation system by the car navigation system. Depending on the time of day and temperature in the house and estimated time of arrival at home, window coverings may be opened or closed and the HVAC system may be turned on to heat or cool the house to an acceptable level. In a preferred embodiment, the opening or closing of the window coverings is coordinated with information from a temperature outside the house. To this end, the temperature outside the house may be used to decide whether to open or close the blinds or not. For example, if it is cooler outside the home than inside the home, such as around dusk, the window shades may be pulled up to see if the house can be cooled naturally before turning on the HVAC system. In preferred embodiments, the home automation system may monitor the rate of change in temperature of the house after the window shades are lifted to determine whether the house will reach a desired temperature by the time the occupant arrives or whether the HVAC system will need to be engaged. Moreover, the home automation system may further calculate an intercept point for turning on the HVAC system to make sure the home reaches the required temperature by the time the occupant arrives. In a preferred embodiment, the intercept point may be calculated by taking the user's arrival time and subtracting the time it will take to heat or cool the house from the current temperature to the desired temperature.

In preferred embodiments, the home automation system may be smart and learn as it is used. For example, the home automation system may keep track of how long it takes to heat or cool the home from a current temperature to a desired temperature. To this end, the home automation system may keep one or more factors measured in temperature/time for example, degrees/min. These factors may be used to allow the home automation system to know when to turn on and when to turn off to heat or cool the home from a desired temperature to a target temperature. To this end, when an occupant is headed home, the home automation system will be able to calculate an intercept point for engaging the HVAC system such that the home reaches the desired temperature right as the occupant arrives. By not coming on too soon, the home automation system can save considerable energy has it does not have to maintain the home at a target temperature for longer than it needs to.

In preferred embodiments, the home automation system may not only keep track of how long it takes to heat and cool the home and learn and calculate heating and cooling rates of change, it may also learn and calculate rates of change for other parameters such as humidity and air quality, to name a few.

As the car approaches the house, depending on the time of day, window coverings may be opened and certain lights may be turned on. As the garage door is opened, the alarm system may be turned off. In a preferred embodiment, the home automation system may coordinate with the occupant's cell phone or car navigation system to ensure it is the home owner or an approved occupant that is entering the garage before automatically turning off the alarm.

When the owner steps out of the car and enters the house, the garage door may be closed and the window coverings may open or close.

In another scenario, the home automation system may be alerted of a natural disaster in close proximity and/or headed towards the home. As an example, an earthquake or strong wind may be detected not too far from home and heading towards the house. Depending on the magnitude, an audible and visible alert may be given; lights may be turned on; window coverings may be opened or closed; doors may be unlocked; the garage door may be opened; the gas valve may be closed; if needed, the number of occupants and their location in the house may be reported to emergency services personnel.

In preferred embodiments, the home automation system may also learn or be programmed for personal preferences. Different occupants may not only request or prefer different environmental settings, but may also tolerate a larger range of drift away from those environmental targets. For example, an occupant with a lung condition, may prefer better air quality than other occupants. When the occupant with the lung condition is in the house, the system may control the air quality to one particular level and acceptable range away from that level. However, if the system detects that particular occupant is not in the house, the system may relax the air quality requirements to another level and tolerance. The home automation system may use or be integrated with the occupants smart phones in order to facilitate knowing locations.

Generally, temperature settings depend on personal preferences and time of day. In preferred embodiments, the system may learn these preferences over time for each individual occupant. Typically, the optimal humidity level is around 40% RH; the CO₂ level is not to exceed 900 ppm to avoid drowsiness and poor air; the CO level cannot exceed 9 ppm for prolonged exposure. In addition, the optimal illumination level depends on activity, 500-1000 lux for normal activities and 1500-2000 lux for precision and detailed work.

Although the embodiments have been described with reference to preferred configurations and specific examples, it will readily be appreciated by those skilled in the art that many modifications and adaptations of the various systems and methods described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. A method of controlling the temperature and humidity in a plurality of spaces comprising:
receiving inputs from a temperature sensor, a humidity sensor, an occupancy sensor, a door sensor, and a window sensor;
determining a first space is occupied and a second space is unoccupied;
determining a first space has both doors and windows closed; and,
directing a motorized vent to shift air flow towards the first area and away from the second area, wherein the air flow is provided by a blower and passes an evaporator, a burner and a humidifier.

2. The method of claim 1, further comprising comparing inputs from the temperature sensor and humidity sensor with temperature set points and humidity set points respectively.

3. The method of claim 2, further comprising determining that the humidity and temperature of the first space is within the temperature set point range and humidity set point range respectively and causing a motorized vent to shift air flow from the evaporator and the burner and the humidifier towards the second space.

4. The method of claim 3, further comprising causing motorized window blinds to close.

5. The method of claim 4, further comprising initiating the blower.

6. The method of claim 1, further comprising calculating a rate of change of temperature for the first area by recording temperatures over a period of time.

7. The method of claim 6, further comprising calculating a start time to turn on the blower and the burner or evaporator based on an occupant arrival time and the rate of change.

8. A system for controlling an environment in a plurality of separate spaces comprising:
a microcontroller;
a temperature sensor in communication with the microcontroller;
a humidity sensor in communication with the microcontroller;
an occupancy sensor in communication with the microcontroller;
door sensors in communication with the microcontroller;
window sensors in communication with the microcontroller;
a compressor and fan in communication with the microcontroller;
a gas valve and igniter in communication with the microcontroller;
a humidifier in communication with the microcontroller;
motorized vents in communication with the microcontroller; and
a duct system forming a path for air flow from the evaporator, burner and humidifier to the plurality of separate spaces;
wherein the microcontroller is programmed to receive inputs from the temperature and humidity sensors and compare them against a set of target temperature and humidity values and,
wherein the microcontroller is programmed to receive inputs from the occupancy, door, and window sensors and,
wherein the microcontroller determines a first set of spaces from the plurality of spaces that have temperature or humidity inputs outside their set of target temperature and humidity values and,
wherein the microcontroller determines a second set of spaces from the first set of spaces where inputs from the occupancy, door and window sensors determine that the space is: occupied, with windows closed and doors closed and,
wherein the microcontroller causes the motorized vents to direct air from the evaporator and the burner and the humidifier to the second set of spaces.

9. The system of claim 8, further comprising a blower located adjacent a portion of the duct system and in communication with the microcontroller.

10. The system of claim 9, further comprising motorized window blinds.

11. A controller for controlling an environment in a plurality of spaces comprising:
a microcontroller designed to receive inputs from a temperature sensor, a humidity sensor, an occupancy sensor, a door sensor, and a window sensor;
the microcontroller further designed to send outputs to a blower, an evaporator and fan, a gas valve and igniter, motorized vents and a humidifier;
wherein the microcontroller is programmed to receive inputs from the temperature, humidity, occupancy, door, and window sensors and accordingly cause the motorized vents to close and open such that air from the evaporator and burner and the humidifier are directed to spaces that are both occupied and have their external door and external windows closed.

12. The controller of claim 11, further designed to receive an input from a CO₂ sensor and cause a window or skylight to open if a CO₂ level is above a CO₂ set point.

13. The controller of claim 12, further designed to control motorized window blinds.
